(19) United States
(12) Patent Application Publication
(10) Pub. No.: US 2026/0230224 A1
(43) Pub. Date: Aug. 6, 2026

(54) STATIC PREAMBLE PUNCTURING PATTERNS WLAN RANGING AND SENSING SUPPORT

(71) Applicant: MEDIATEK INC., Hsinchu City (TW)

(72) Inventors: Shuling FENG, San Jose, CA (US); Jianhan LIU, San Jose, CA (US); Thomas Edward PARE, Jr., San Jose, CA (US)

(21) Appl. No.: 19/151,438

(22) PCT Filed: Feb. 1, 2024
(86) PCT No.: PCT/CN2024/075272

§ 371 Date: Jul. 28, 2025

Related U.S. Application Data
(60) Provisional application No. 63/483,025, filed on Feb. 3, 2023.
(60) Provisional application No. 63/488,199, filed on Mar. 3, 2023.
(60) Provisional application No. 63/590,496, filed on Oct. 16, 2023.

(51) Int. Cl. H04L 1/00; H04W 56/00; H04W 84/12

(52) U.S. Cl. CPC H04L 1/0069; H04W 56/0015; H04W 84/12

(57) ABSTRACT

Various techniques pertaining to support of static preamble puncturing patterns in wireless local area network (WLAN) ranging and sensing are described. A processor of an apparatus (e.g., a station (STA)) signals a support of one or more static preamble puncture patterns. The processor also performs at least one of ranging and sensing in a WLAN with at least one of the one or more static preamble puncture patterns.

### CROSS REFERENCE TO RELATED PATENT APPLICATION

The present disclosure is part of a non-provisional patent application claiming the priority benefit of U.S. Provisional Patent Application Nos. 63/483,025, 63/488,199 and 63/590,496, filed 3 Feb. 2023, 3 Mar. 2023 and 16 Oct. 2023, respectively, the contents of which herein being incorporated by reference in their entirety.

### TECHNICAL FIELD

The present disclosure is generally related to wireless communications and, more particularly, to support of static preamble puncturing patterns in wireless local area network (WLAN) ranging and sensing.

### BACKGROUND

Unless otherwise indicated herein, approaches described in this section are not prior art to the claims listed below and are not admitted as prior art by inclusion in this section.

In wireless communications such as WiFi (or Wi-Fi) and WLANs, there are different proposals in the Institute of Electrical and Electronics Engineers (IEEE) 802.11bk task group on the static preamble puncturing patterns. A first proposal pertains to IEEE 802.11bk support of all 320 MHz bandwidth (BW320) static preamble puncturing patterns specified in Table 36-30 of the specification. A second proposal pertains to IEEE 802.11bk support of only non-punctured 320 MHz and continuous 240 MHz physical-layer protocol data units (PPDUs). That is, under this second proposal, IEEE 802.11bk would only support BW320 static puncture pattern 1111 1111, xx11 1111, and 1111 11xx from Table 36-30.

There are, nevertheless, pros and cons associated with each of these proposals. With respect to the first proposal, while it would maximize the ranging bandwidth regardless of the primary channel location, the support of all 25 static puncture patterns would complicate receiver ranging calculation and testing. Besides, some BW320 static puncturing patterns may not provide much ranging accuracy gain compared to ranging only on the primary 160 MHz band if available. With respect to the second proposal, while it would minimize the cases to design ranging calculation and testing, it would inevitably limit IEEE 802.11bk usage. For some puncturing patterns where IEEE 802.11bk ranging still shows large potential gain, an initiating station (ISTA) may fall back to the primary band to perform IEEE 802.11az ranging with bandwidth≤160 MHz because of no support of these static puncture patterns.

Therefore, there is a need for a solution of support of static preamble puncturing patterns in WLAN ranging and sensing.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to provide schemes, concepts, designs, techniques, methods and apparatuses pertaining to the support of static preamble puncturing patterns in WLAN ranging and sensing. It is believed that various schemes proposed herein may address or otherwise alleviate the aforementioned issue(s). Under the proposed schemes, static puncture patterns specified in Table 36-30 may be categorized into several sets. Accordingly, an IEEE 802.11bk ranging device may signal which set(s) of static puncture pattern(s) it supports. Moreover, during a ranging negotiation phase, the ISTA may signal the static preamble puncture pattern set(s) it supports in an initial fine timing measurement request (IFTMR), and a responding station (RSTA) may choose equal or small set(s) based on its capability of puncture pattern support of ranging and may signal such information in an initial fine timing measurement (IFTM). Additionally, the puncture pattern categorization and signaling schemes proposed herein for BW320 ranging may also be applied in BW320 sensing. Moreover, under the proposed schemes, EHT ranging may support preamble puncturing for 80 MHz (BW80 ) and 160 MHz (BW160 ) channel bandwidths in addition to 320 MHz. The puncture pattern categorization and signaling schemes proposed for BW80 and BW160 ranging may also be applied in BW80 and BW160 sensing.

In one aspect, a method may involve signaling a support of one or more static preamble puncture patterns. The method may also involve performing at least one of ranging and sensing in a WLAN with at least one of the one or more static preamble puncture patterns.

In another aspect, an apparatus may include a transceiver configured to communicate wirelessly and a processor coupled to the transceiver. The processor may signal a support of one or more static preamble puncture patterns. The processor may also perform at least one of ranging and sensing in a WLAN with at least one of the one or more static preamble puncture patterns.

It is noteworthy that, although description provided herein may be in the context of certain radio access technologies, networks and network topologies such as, WiFi/WLAN, the proposed concepts, schemes and any variation(s)/derivative(s) thereof may be implemented in, for and by other types of radio access technologies, networks and network topologies such as, for example and without limitation, Bluetooth, ZigBee, 5^{th} Generation (5G)/New Radio (NR), Long-Term Evolution (LTE), LTE-Advanced, LTE-Advanced Pro, Internet-of-Things (IoT), Industrial IoT (IIoT) and narrowband IoT (NB-IoT). Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation to clearly illustrate the concept of the present disclosure.

FIG. 1 is a diagram of an example network environment in which various solutions and schemes in accordance with the present disclosure may be implemented.

FIG. 2 is a diagram of an example design in accordance with an implementation of the present disclosure.

FIG. 3 is a diagram of an example design in accordance with an implementation of the present disclosure.

FIG. 4 is a diagram of an example design in accordance with an implementation of the present disclosure.

FIG. 5 is a diagram of an example design in accordance with an implementation of the present disclosure.

FIG. 6 is a diagram of an example design in accordance with an implementation of the present disclosure.

FIG. 7 is a diagram of an example design in accordance with an implementation of the present disclosure.

FIG. 8 is a diagram of an example design in accordance with an implementation of the present disclosure.

FIG. 9 is a diagram of an example design in accordance with an implementation of the present disclosure.

FIG. 10 is a block diagram of an example communication system in accordance with an implementation of the present disclosure.

FIG. 11 is a flowchart of an example process in accordance with an implementation of the present disclosure.

### DETAILED DESCRIPTION OF PREFERRED EMBODIMENTS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to support of static preamble puncturing patterns in WLAN ranging and sensing. According to the present disclosure, a number of possible solutions may be implemented separately or jointly. That is, although these possible solutions may be described below separately, two or more of these possible solutions may be implemented in one combination or another.

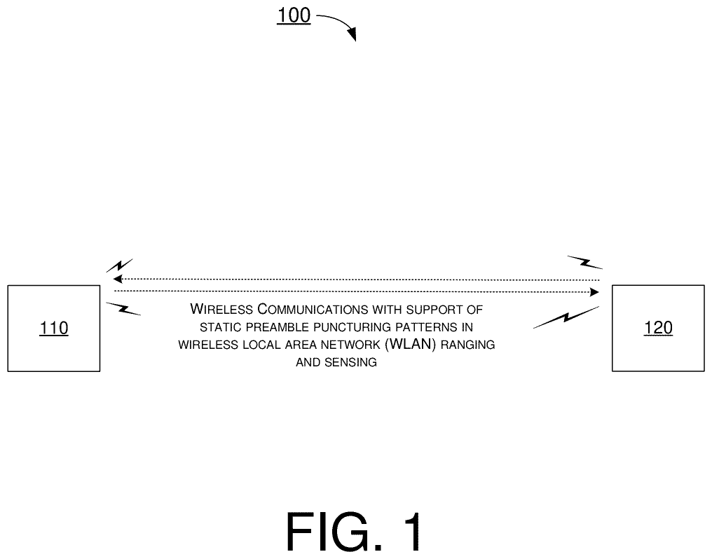

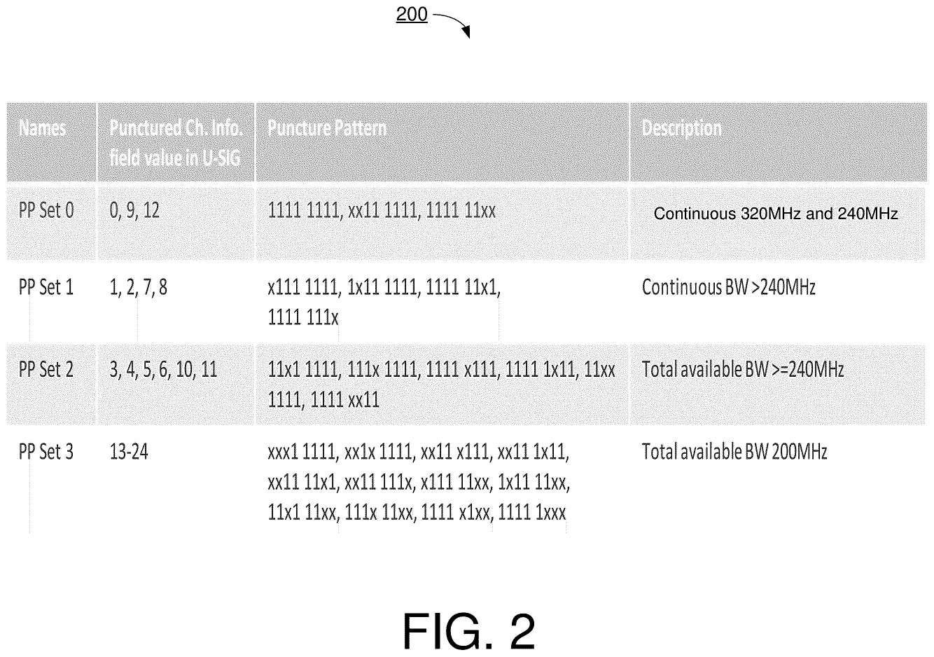

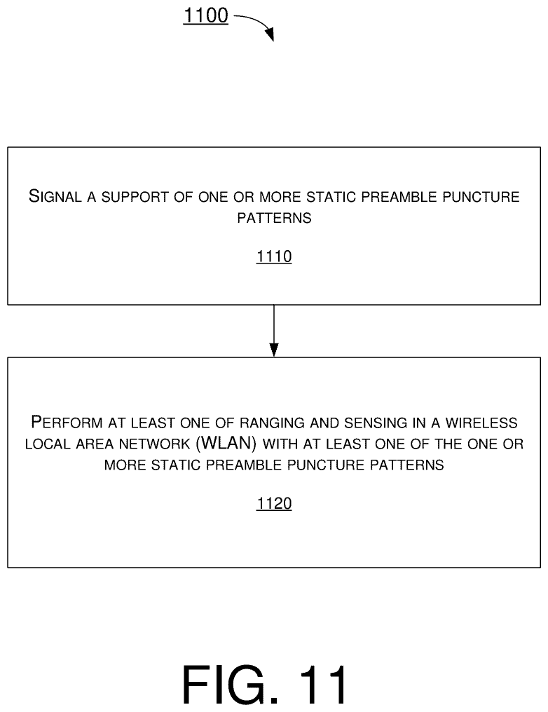

FIG. 1 illustrates an example network environment 100 in which various solutions and schemes in accordance with the present disclosure may be implemented. FIG. 2 ~FIG. 11 illustrate examples of implementation of various proposed schemes in network environment 100 in accordance with the present disclosure. The following description of various proposed schemes is provided with reference to FIG. 1~FIG. 11.

Referring to FIG. 1, network environment 100 may involve at least a station (STA) 110 communicating wirelessly with a STA 120. Either of STA 110 and STA 120 may be an access point (AP) STA or, alternatively, either of STA 110 and STA 120 may function as a non-AP STA. In some cases, STA 110 and STA 120 may be associated with a basic service set (BSS) in accordance with one or more IEEE 802.11 standards (e.g., IEEE 802.11bk and future-developed standards). Each of STA 110 and STA 120 may be configured to communicate with each other by utilizing the various proposed schemes described below. It is noteworthy that, while the various proposed schemes may be individually or separately described below, in actual implementations some or all of the proposed schemes may be utilized or otherwise implemented jointly. Of course, each of the proposed schemes may be utilized or otherwise implemented individually or separately.

As mentioned above, there are pros and cons associated with each of these proposals. With respect to the first proposal, while it would maximize the ranging bandwidth regardless of the primary channel location, the support of all 25 static puncture patterns would complicate receiver ranging calculation and testing. Besides, some BW320 static puncturing patterns may not provide much ranging accuracy gain compared to ranging only on the primary 160 MHz band if available. With respect to the second proposal, while it would minimize the cases to design ranging calculation and testing, it would inevitably limit IEEE 802.11bk usage. For some puncturing patterns where IEEE 802.11bk ranging still shows large potential gain, an ISTA may fall back to the primary band to perform IEEE 802.11az ranging with bandwidth ≤160 MHz because of no support of these static puncture patterns.

Moreover, IEEE 802.11bk supports extremely-high-throughput (EHT)-based ranging with 320 MHz channel bandwidth with puncturing patterns specified in Table-36-30 (Definition of the Punctured Channel Information field in the Universal Signal (U-SIG) field for an EHT multi-user (MU) PPDU using non-orthogonal frequency-division multiple-access (non-OFDMA) transmission). However, it tends to be difficult to have the entire 320 MHz bandwidth available in the 6 GHz band because of existence of incumbent signal(s). Supporting preamble puncturing patterns allows better ranging accuracy compared to falling back to a primary 160 MHz for ranging. Regarding signaling in 320 MHz bandwidth, 320 MHz is signaled in the Bandwidth field in the U-SIG and puncturing patterns are indicated in the Punctured Channel Information field in the U-SIG.

On the other hand, IEEE 802.11be specifies preamble puncturing patterns for channel bandwidths 80 MHz and 160 MHz in addition to 320 MHz in Table 36-30 of the specification. Preamble puncturing may also occur in 80 MHz and 160 MHz channel bandwidths in the 6 GHz band to avoid incumbent signal(s), and preamble puncturing may further occur in 80 MHz and 160 MHz channel bandwidths in the 5 GHz band to avoid radar occupied bands. Thus, it would be natural to expand ranging-capable EHT devices to support ranging with puncturing patterns specified in Table 36-30 for 80 MHz and 160 MHz channel bandwidths.

Under a proposed scheme (Proposal 1) in accordance with the present disclosure, one or more sets of selected static preamble puncture patterns may be defined in IEEE 802.11bk. Under this proposal, there may be several options (Option 1, Option 2, Option 3 and Option 4) of puncture pattern categorization, which are described below. It is noteworthy that the definition of static preamble puncture (PP) pattern sets are not limited to the examples provided herein.

FIG. 2 illustrates an example design 200 under Option 1. Referring to FIG. 2, there may be four static PP pattern sets, namely PP Set 0, PP Set 1, PP Set 2 and PP Set 3. Specifically, PP Set 0 may be suitable and utilized for continuous 320 MHz and 240 MHz, with Punctured Channel Information field values in a U-SIG field being 0, 9 and 12. Additionally, PP Set 1 may be suitable and utilized for continuous 240 MHz, with Punctured Channel Information field values in the U-SIG being 1, 2, 7 and 8. Moreover, PP Set 2 may be suitable and utilized for total available 240 MHz, with Punctured Channel Information field values in the U-SIG being 3, 4, 5, 6, 10 and 11. Furthermore, PP Set 3 may be suitable and utilized for total available 200 MHz, with Punctured Channel Information field values in the U-SIG being 13~24.

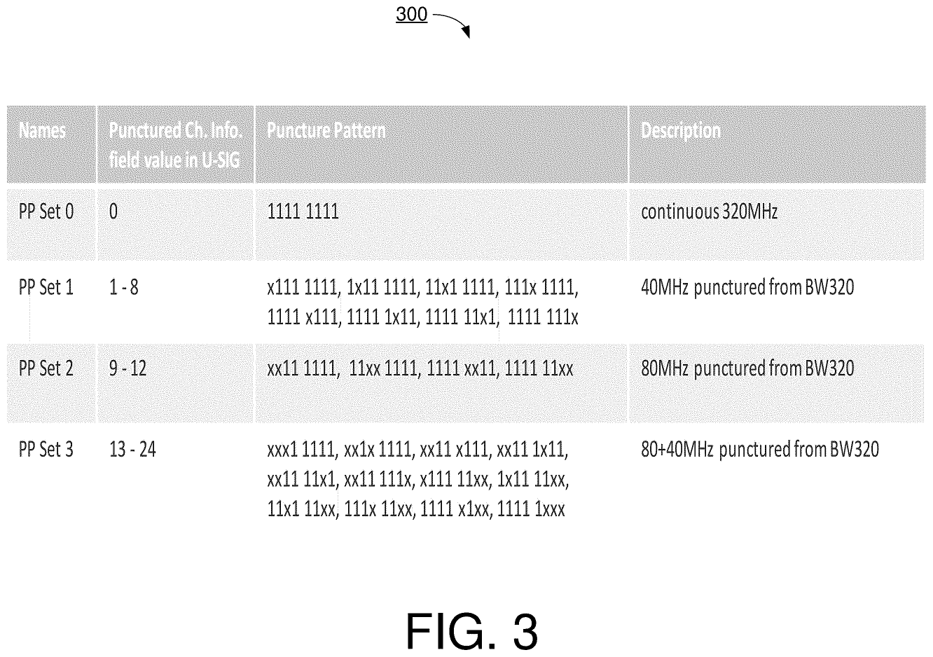

FIG. 3 illustrates an example design 300 under Option 2. Referring to FIG. 3, there may be four static PP pattern sets, namely PP Set 0, PP Set 1, PP Set 2 and PP Set 3. Specifically, PP Set 0 may be suitable and utilized for continuous 320 MHz, with Punctured Channel Information field values in the U-SIG being 0. Additionally, PP Set 1 may be suitable and utilized for 40 MHz punctured from BW 320, with Punctured Channel Information field values in the U-SIG being 1~8. Moreover, PP Set 2 may be suitable and utilized for 80 MHz punctured from BW320, with Punctured Channel Information field values in the U-SIG being 9 ~12. Furthermore, PP Set 3 may be suitable and utilized for 80+40MHz punctured from BW320, with Punctured Channel Information field values in the U-SIG being 13~24.

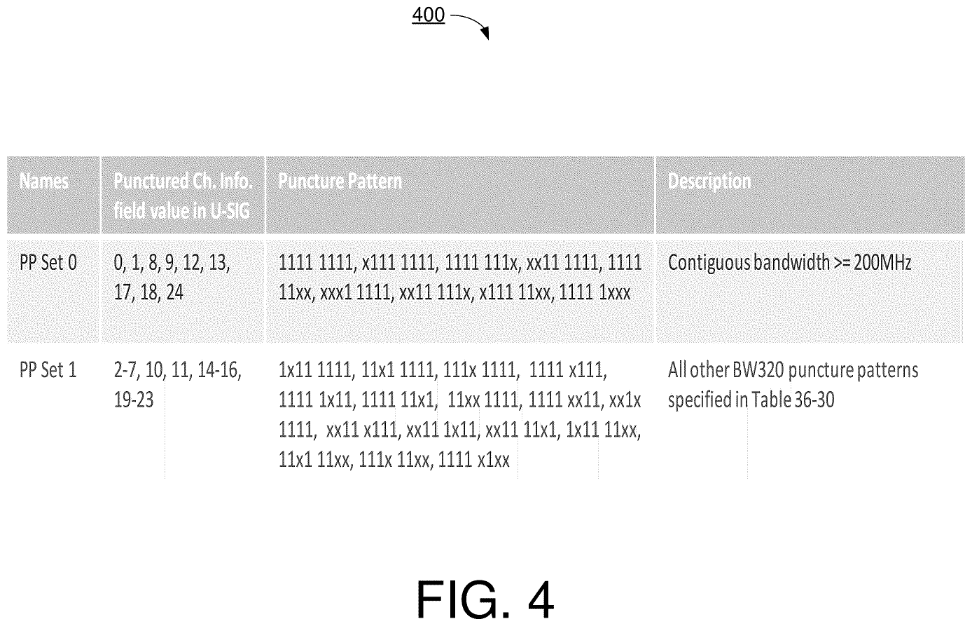

FIG. 4 illustrates an example design 400 under Option 3. Referring to FIG. 4, there may be two static PP pattern sets, namely PP Set 0 and PP Set 1. Specifically, PP Set 0 may be suitable and utilized for a contiguous bandwidth greater than or equal to 200 MHz, with Punctured Channel Information field values in the U-SIG specified in Table 36-30 being 0, 1, 8, 9, 12, 13, 17, 18 and 24. Additionally, PP Set 1 may be suitable and utilized for all other BW320 puncture patterns specified in Table 36-30, with Punctured Channel Information field values in the U-SIG specified in Table 36-30 being 2~7, 10, 11, 14~16 and 19~23.

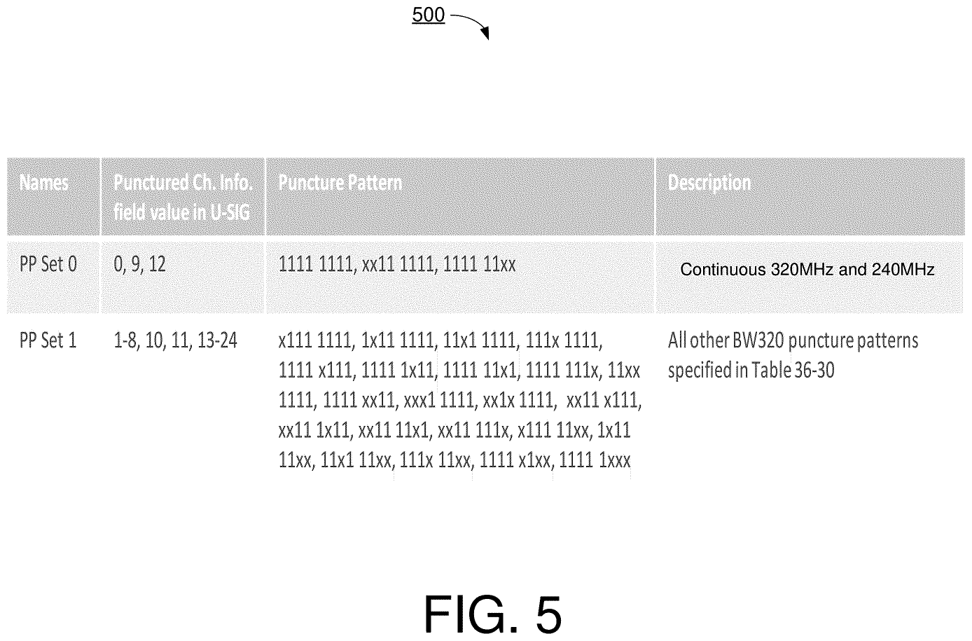

FIG. 5 illustrates an example design 500 under Option 4. Referring to FIG. 5, there may be two static PP pattern sets, namely PP Set 0 and PP Set 1. Specifically, PP Set 0 may be suitable and utilized for continuous 320 MHz and 240 MHz, with Punctured Channel Information field values in the U-SIG being 0, 9 and 12. Additionally, PP Set 1 may be suitable and utilized for all other BW320 puncture patterns specified in Table 36-30, with Punctured Channel Information field values in the U-SIG being 1~8, 10, 11 and 13~24.

Under a proposed scheme (Proposal 2) in accordance with the present disclosure, IEEE 802.11bk ranging sessions may be negotiated only for supported sets of static preamble puncture patterns. Under this proposed scheme, STAs may be allowed to choose or select which set(s) of static preamble puncture patterns it support for IEEE 802.11bk ranging. Both the ISTA and RSTA may signal the static preamble puncture patterns they support during the ranging negotiation phase.

During the negotiation phase, the STAs may obtain a current static preamble puncture pattern from beacon frame(s) transmitted by an AP. The ISTA may check the current static preamble puncture pattern to determine whether it is supported before the ISTA sends an IFTMR frame to the RSTA. In case that the current static preamble puncture pattern is not supported by the ISTA, the ISTA may fall back to a primary band with bandwidth≤160 MHz to start negotiation of an IEEE 802.11az ranging session. Additionally, the ISTA may set the Max Bandwidth in the Format And Bandwidth field in the IFTMR frame to a value depending on the puncture pattern and primary channel location. In an event that no puncture occurs in the primary 160 MHz band, the ISTA may set the value to 3, 4 or 5 for 160 MHz. In an event that puncture occurs in the primary 160 MHz but no puncture occurs in the primary 80 MHz band, the ISTA may set the value to 2 for 80 MHz. In an event that puncture occurs in the primary 80 MHz but no puncture occurs in the primary 40 MHz band, the ISTA may set the value to 1 for 40 MHz. In case that the RSTA agrees with the ISTA's request, the RSTA may set the Assigned Max Bandwidth in the Format And Bandwidth field in the IFTM frame to a value equal to or smaller than the Max Bandwidth in the IFTMR frame in the same way as in IEEE 802.11az. Otherwise (in case that the current static preamble puncture pattern is supported by the ISTA), the ISTA may start to negotiate an IEEE 802.11bk ranging session by setting the Max Bandwidth in the Format And Bandwidth field in the IFTMR to BW320 and signal puncture pattern (i.e., PP) sets supported by the ISTA. In case that the RSTA agrees with the ISTA's request and that the Assigned Max Bandwidth is 320 MHz, the RSTA may set the Assigned Max Bandwidth in the Format And Bandwidth field to BW320 and signal PP sets agreed by the RSTA to support. The agreed PP sets may be equal to or smaller than that indicated in the IFTMR.

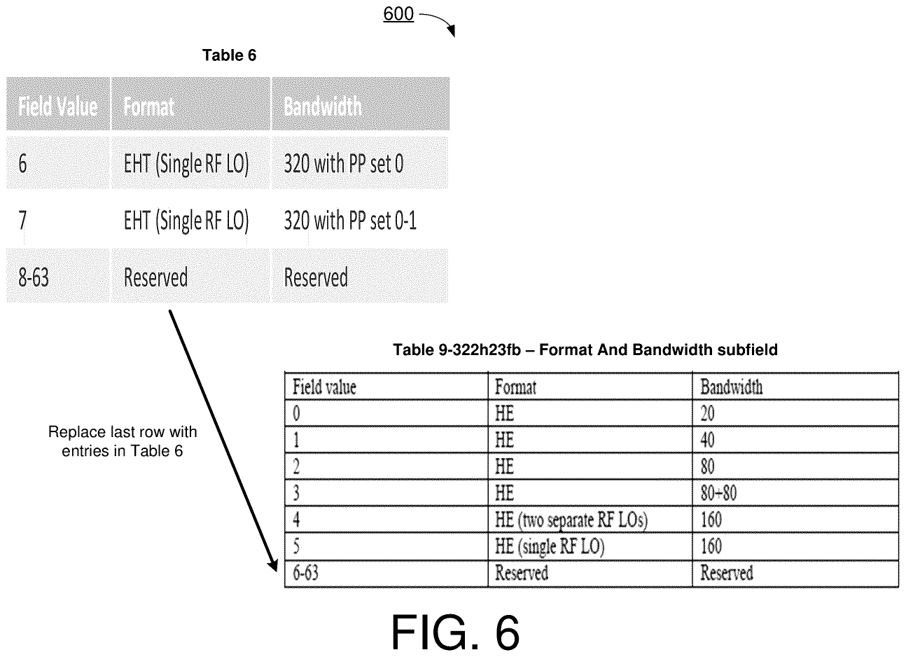

Under a proposed scheme (Proposal 3) in accordance with the present disclosure, the supported static preamble puncture pattern sets may be signaled in the Ranging Parameter field in IEEE 802.11bk. FIG. 6 illustrates an example design 600 under this proposed scheme. Referring to FIG. 6, which is an illustrative and non-limiting example, Format and Bandwidth field values may be added for IEEE 802.11bk. For instance, the last row of Table 9-322h23fb of the IEEE 802.11 specification may be replaced with entries in the table (Table 6) shown in FIG. 6. In design 600, the IEEE 802.11bk Format and Bandwidth field value of 6 may be defined as mandatory supported PP set while other values (e.g., 7, 8 or 9) may be defined as optional supported PP sets.

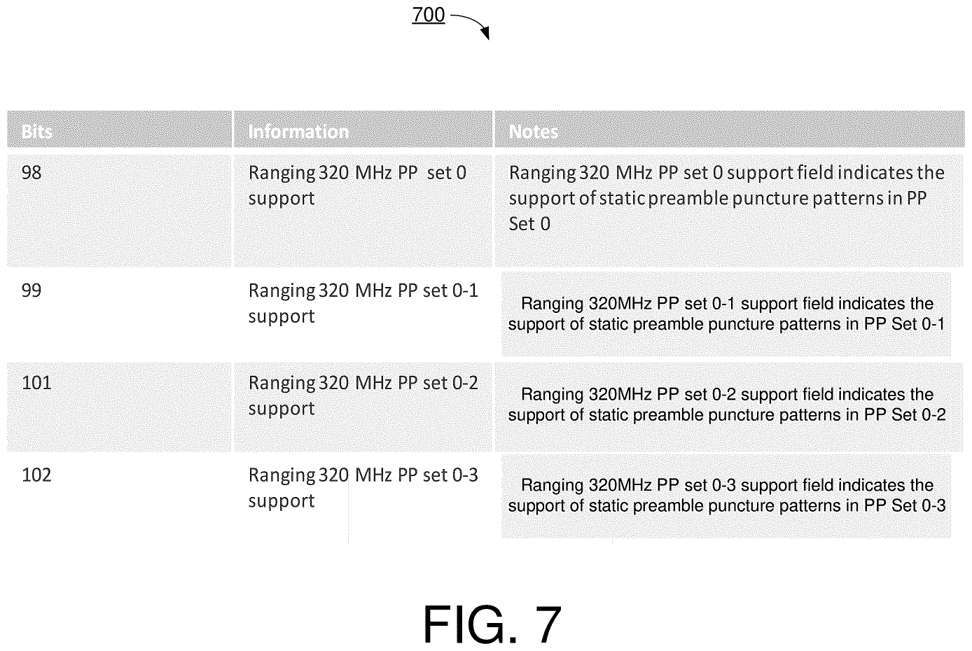

Under a proposed scheme (Proposal 4) in accordance with the present disclosure, support of static preamble PP sets may be signaled in the Extended Capability field. It is noteworthy that a given STA's capability of supporting static preamble puncture patterns is vendor specific. Under this proposed scheme, the capability of an IEEE 802.11bk-compliant STA to support static preamble puncture pattern sets may be defined in the Extended Capability field. FIG. 7 illustrates an example design 700 under this proposed scheme. Referring to FIG. 7, the table shows an example of added entries in Table 9-153 (Extended Capabilities field) for IEEE 802.11bk. Notably, in the case of Option 3 in Proposal 1, 320 MHz puncture patterns in Table 36-30 are categorized into two sets and, as in such a case, the last two rows in the table shown in FIG. 7 would not apply.

Under a proposed scheme (Proposal 5) in accordance with the present disclosure, EHT ranging may support preamble puncturing for the 80 MHz and 160 MHz channel bandwidths. That is, EHT devices supporting IEEE 802.11bk may benefit in ranging performance in case they also support ranging with preamble puncturing for channel bandwidths 80 MHz and 160 MHz. The IEEE 802.11be standard specifies preamble puncturing patterns for channel bandwidths 80 MHz and 160 MHz in addition to 320 MHz in Table 36-30. Since EHT devices already support these puncturing patterns, there should be no extra cost on hardware implementation except ranging Time of Arrival (TOA) calculations for punctured 80 MHz and 160 MHz in ISTA and RSTA receivers. Under the proposed scheme, with respect to signaling of EHT ranging, EHT Ranging NDP in IEEE 802.11bk may be expanded from 320 MHz bandwidth to include 80 MHz, 160 MHz and 320 MHz bandwidth. Additionally, EHT TB ranging NDP in IEEE 802.11bk may be expanded from 320 MHz bandwidth to include 80 MHz, 160 MHz and 320 MHz bandwidth. Moreover, existing IEEE 802.11be bandwidth and puncturing patterns signaling for 80 MHz, 160 MHz and 320 MHz may be utilized. For instance, 80 MHz, 160 MHz and 320 MHz may be signaled in the Bandwidth field in U-SIG, and puncture patterns may be signaled in the Punctured Channel Information field in U-SIG (Table 36-30).

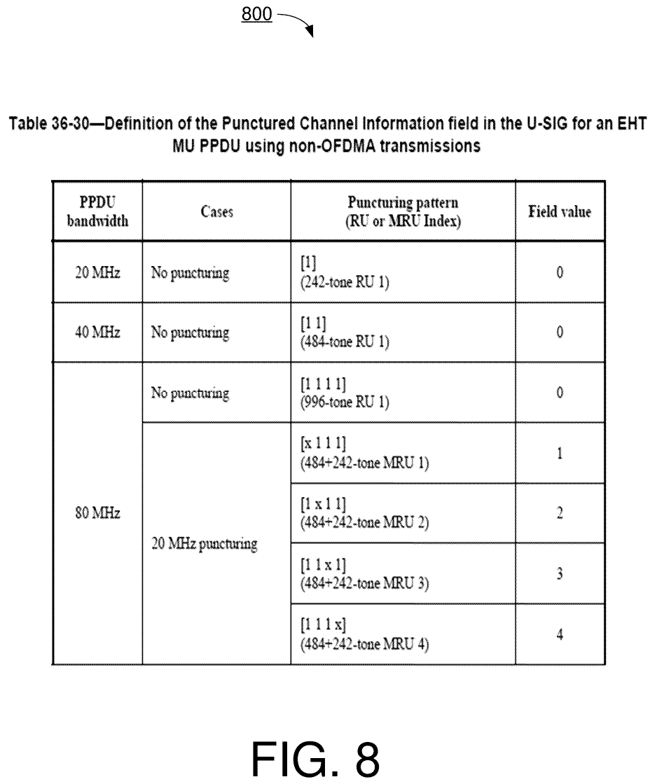

Under a proposed scheme (Proposal 6) in accordance with the present disclosure, EHT ranging may support preamble puncturing for the 80 MHz channel bandwidth. FIG. 8 illustrates an example design 800 under this proposed scheme. By IEEE 802.11be specification, an EHT device whose channel bandwidth is 80 MHz needs to support any of the puncturing patterns specified in Table 36-30, shown in FIG. 8, for 80 MHz non-OFDMA transmissions. Ranging-capable EHT devices whose channel bandwidth is 80 MHz may also support any of the puncturing patterns specified in Table 36-30 for 80 MHz ranging measurement frame exchanges. Under the proposed scheme, EHT devices may improve ranging accuracy by supporting 80 MHz preamble puncturing patterns instead of falling back to a primary 40 MHz for ranging. For puncturing pattern [x111] and [111x], instead of falling back to the primary 40 MHz for ranging, EHT devices may perform ranging with 60 MHz contiguous bandwidth, thereby improving ranging accuracy. In case that EHT devices do not support ranging with puncturing pattern [1x11] and [11x1], ranging may fall back to the primary 40 MHz. In case they do support these two puncture patterns for ranging and ranging is negotiated for 80 MHz, the EHT devices may exchange ranging measurement frames with punctured 80 MHz and perform TOA calculation on contiguous 40 MHz or non-contiguous 60 MHz band. The puncture patterns may be categorized as follows: (1) PP set 0 (continuous bandwidth (BW) and BW≥60 MHz): field value=0, 1, 4; (2) PP set 1 (other patterns): field value=2, 3; (3) a field value n may be added to Table 9-332h23fb (Format And Bandwidth subfield) to signal ISTA/RSTA's support of PP set 0; (4) a field value n+1 may be added to Table 9-322h23fb (Format And Bandwidth subfield) to signal ISTA/RSTA's support of PP set 0 and PP set 1; and (5) value n and value n+1 may be from the reserved field values in Table 9-322h23fb.

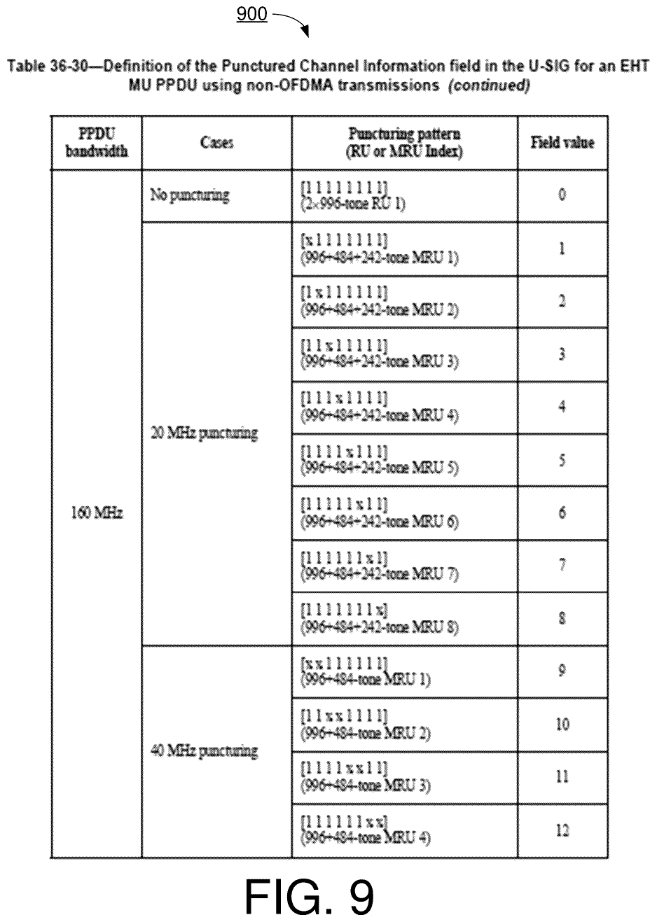

Under a proposed scheme (Proposal 7) in accordance with the present disclosure, EHT ranging may support preamble puncturing for the 160 MHz channel bandwidth. FIG. 9 illustrates an example design 900 under this proposed scheme. By IEEE 802.11be specification, an EHT device whose channel bandwidth is 160 MHz needs to support any of the puncturing patterns specified in Table 36-30, shown in FIG. 9, for 160 MHz non-OFDMA transmissions. Ranging-capable EHT devices whose channel bandwidth is 160 MHz may also support any of the puncturing patterns specified in Table 36-30 for 160 MHz ranging measurement frame exchanges. Under the proposed scheme, when preamble puncturing occurs in a 160 MHz channel bandwidth, EHT devices may improve ranging accuracy by supporting 160 MHz preamble puncturing patterns instead of falling back to a primary 80 MHz for ranging. The puncture patterns may be categorized as follows: (1) PP set 0 (continuous BW and BW≥120 MHz): field value=0, 1, 8, 9, 12; (2) PP set 1 (other patterns): field value=2, 3~7, 10, 11; (3) a field value m may be added to Table 9-322h23fb (Format And Bandwidth subfield) to signal ISTA/RSTA's support of PP set 0; (4) a field value m+1 may be added to Table 9-322h23fb (Format And Bandwidth subfield) to signal ISTA/RSTA's support of PP set 0 and PP set 1; and (5) value m and value m+1 may be from the reserved field values in Table 9-322h23fb.

Under this proposed scheme, ranging accuracy may be improved by supporting 160 MHz preamble puncturing patterns. For puncturing patterns [x111 1111] and [1111 111x], instead of falling back to the primary 80 MHz for ranging, EHT devices may perform ranging with a 140 MHz contiguous bandwidth. For puncturing patterns [xx11 1111] and [1111 11xx], instead of falling back to the primary 80 MHz for ranging, EHT devices may perform ranging with a 120 MHz contiguous bandwidth. In case that EHT devices do not support ranging with puncture patterns in PP set 1 (e.g., [1x11 1111], [1111 11x1], [11x1 1111], [1111 1x11], [111x 1111], [1111 x1111], [11xx 1111] and [1111 xx11]), ranging may fall back to the primary 40 MHz. In case that they support these puncture patterns for ranging and ranging is negotiated for 160 MHz, then the EHT devices may exchange ranging measurement frames with punctured 160 MHz and perform TOA calculation on the contiguous part of the band or on a non-contiguous band.

### Illustrative Implementations

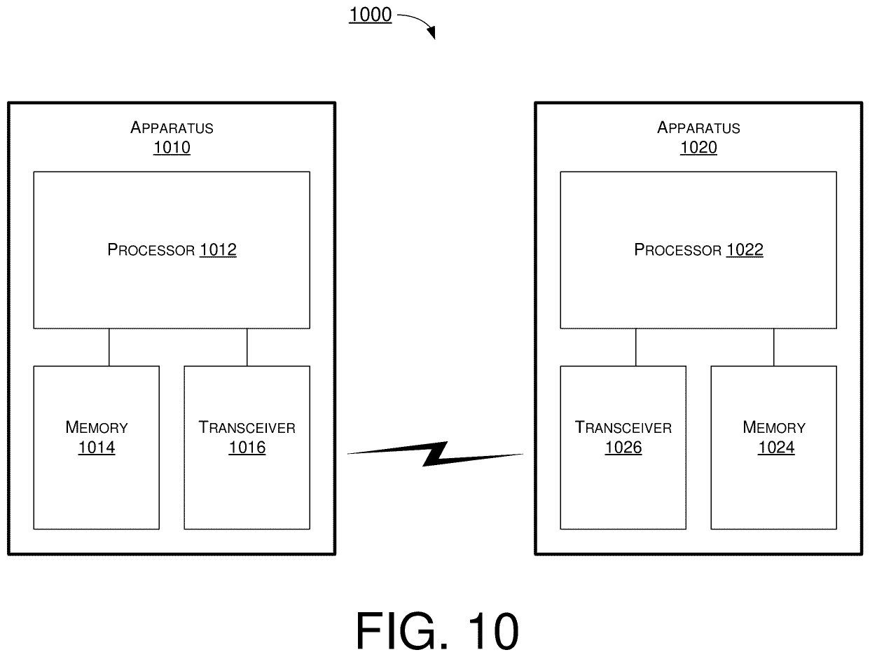

FIG. 10 illustrates an example system 1000 having at least an example apparatus 1010 and an example apparatus 1020 in accordance with an implementation of the present disclosure. Each of apparatus 1010 and apparatus 1020 may perform various functions to implement schemes, techniques, processes and methods described herein pertaining to support of static preamble puncturing patterns in WLAN ranging and sensing, including the various schemes described above with respect to various proposed designs, concepts, schemes, systems and methods described above as well as processes described below. For instance, apparatus 1010 may be implemented in STA 110 and apparatus 1020 may be implemented in STA 120, or vice versa.

Each of apparatus 1010 and apparatus 1020 may be a part of an electronic apparatus, which may be a non-AP STA or an AP STA, such as a portable or mobile apparatus, a wearable apparatus, a wireless communication apparatus or a computing apparatus. When implemented in a STA, each of apparatus 1010 and apparatus 1020 may be implemented in a smartphone, a smart watch, a personal digital assistant, a digital camera, or a computing equipment such as a tablet computer, a laptop computer or a notebook computer. Each of apparatus 1010 and apparatus 1020 may also be a part of a machine type apparatus, which may be an IoT apparatus such as an immobile or a stationary apparatus, a home apparatus, a wire communication apparatus or a computing apparatus. For instance, each of apparatus 1010 and apparatus 1020 may be implemented in a smart thermostat, a smart fridge, a smart door lock, a wireless speaker or a home control center. When implemented in or as a network apparatus, apparatus 1010 and/or apparatus 1020 may be implemented in a network node, such as an AP in a WLAN.

In some implementations, each of apparatus 1010 and apparatus 1020 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. In the various schemes described above, each of apparatus 1010 and apparatus 1020 may be implemented in or as a STA or an AP. Each of apparatus 1010 and apparatus 1020 may include at least some of those components shown in FIG. 10 such as a processor 1012 and a processor 1022, respectively, for example. Each of apparatus 1010 and apparatus 1020 may further include one or more other components not pertinent to the proposed scheme of the present disclosure (e.g., internal power supply, display device and/or user interface device), and, thus, such component(s) of apparatus 1010 and apparatus 1020 are neither shown in FIG. 10 nor described below in the interest of simplicity and brevity.

In one aspect, each of processor 1012 and processor 1022 may be implemented in the form of one or more single-core processors, one or more multi-core processors, one or more RISC processors or one or more CISC processors. That is, even though a singular term “a processor” is used herein to refer to processor 1012 and processor 1022, each of processor 1012 and processor 1022 may include multiple processors in some implementations and a single processor in other implementations in accordance with the present disclosure. In another aspect, each of processor 1012 and processor 1022 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 1012 and processor 1022 is a special-purpose machine specifically designed for support of static preamble puncturing patterns in WLAN ranging and sensing in accordance with various implementations of the present disclosure.

In some implementations, apparatus 1010 may also include a transceiver 1016 coupled to processor 1012. Transceiver 1016 may include a transmitter capable of wirelessly transmitting and a receiver capable of wirelessly receiving data. In some implementations, apparatus 1020 may also include a transceiver 1026 coupled to processor 1022. Transceiver 1026 may include a transmitter capable of wirelessly transmitting and a receiver capable of wirelessly receiving data. It is noteworthy that, although transceiver 1016 and transceiver 1026 are illustrated as being external to and separate from processor 1012 and processor 1022, respectively, in some implementations, transceiver 1016 may be an integral part of processor 1012 as a system on chip (SoC), and transceiver 1026 may be an integral part of processor 1022 as a SoC.

In some implementations, apparatus 1010 may further include a memory 1014 coupled to processor 1012 and capable of being accessed by processor 1012 and storing data therein. In some implementations, apparatus 1020 may further include a memory 1024 coupled to processor 1022 and capable of being accessed by processor 1022 and storing data therein. Each of memory 1014 and memory 1024 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 1014 and memory 1024 may include a type of read-only memory (ROM) such as mask ROM, programmable ROM (PROM), erasable programmable ROM (EPROM) and/or electrically erasable programmable ROM (EEPROM). Alternatively, or additionally, each of memory 1014 and memory 1024 may include a type of non-volatile random-access memory (NVRAM) such as flash memory, solid-state memory, ferroelectric RAM (FeRAM), magnetoresistive RAM (MRAM) and/or phase-change memory.

Each of apparatus 1010 and apparatus 1020 may be a communication entity capable of communicating with each other using various proposed schemes in accordance with the present disclosure. For illustrative purposes and without limitation, a description of capabilities of apparatus 1010, as STA 110, and apparatus 1020, as STA 120, is provided below in the context of example process 1100. It is noteworthy that, although a detailed description of capabilities, functionalities and/or technical features of one of apparatus 1010 and apparatus 1020 is provided below, the same may be applied to the other of apparatus 1010 and apparatus 1020 although a detailed description thereof is not provided solely in the interest of brevity. It is also noteworthy that, although the example implementations described below are provided in the context of WLAN, the same may be implemented in other types of networks.

### Illustrative Processes

FIG. 11 illustrates an example process 1100 in accordance with an implementation of the present disclosure. Process 1100 may represent an aspect of implementing various proposed designs, concepts, schemes, systems and methods described above. More specifically, process 1100 may represent an aspect of the proposed concepts and schemes pertaining to support of static preamble puncturing patterns in WLAN ranging and sensing in accordance with the present disclosure. Process 1100 may include one or more operations, actions, or functions as illustrated by one or more of blocks 1110 and 1120. Although illustrated as discrete blocks, various blocks of process 1100 may be divided into additional blocks, combined into fewer blocks, or eliminated, depending on the desired implementation. Moreover, the blocks/sub-blocks of process 1100 may be executed in the order shown in FIG. 11 or, alternatively, in a different order. Furthermore, one or more of the blocks/sub-blocks of process 1100 may be executed repeatedly or iteratively. Process 1100 may be implemented by or in apparatus 1010 and apparatus 1020 as well as any variations thereof. Solely for illustrative purposes and without limiting the scope, process 1100 is described below in the context of apparatus 1010 implemented in or as STA 110 functioning as a sensing responder (e.g., as a non-AP STA or an AP STA) and apparatus 1020 implemented in or as STA 120 functioning as a sensing initiator (e.g., as an AP STA or a non-AP STA) of a wireless network such as a WLAN in network environment 100 in accordance with one or more of IEEE 802.11 standards. Process 1100 may begin at block 1110.

At 1110, process 1100 may involve processor 1012 of apparatus 1010 signaling, via transceiver 1016, a support of one or more static preamble puncture patterns. Process 1100 may proceed from 1110 to 1120.

At 1120, process 1100 may involve processor 1012 performing, via transceiver 1016, at least one of ranging and sensing in a WLAN with at least one of the one or more static preamble puncture patterns.

In some implementations, with apparatus 1010 functioning as an ISTA, in signaling the support of the one or more static preamble puncture patterns, process 1100 may involve processor 1012 performing certain operations. For instance, process 1100 may involve processor 1012 transmitting, to apparatus 1020 functioning as an RSTA, an IFTMR indicating the support of the one or more static preamble puncture patterns. Moreover, process 1100 may further involve processor 1012 receiving, from apparatus 1020 as the RSTA, an IFTM indicating its support of equal to or fewer than the one or more static preamble puncture patterns.

In some implementations, with apparatus 1010 functioning as an RSTA, in signaling the support of the one or more static preamble puncture patterns, process 1100 may involve processor 1012 performing certain operations. For instance, process 1100 may involve processor 1012 receiving, from apparatus 1020 functioning as an ISTA, an IFTMR indicating its support of one or more other static preamble puncture patterns. Moreover, process 1100 may involve processor 1012 transmitting, to apparatus 1020 as the ISTA, an IFTM indicating the support of the one or more static preamble puncture patterns that are equal to or more than the one or more static preamble puncture patterns.

In some implementations, in signaling the support of the one or more static preamble puncture patterns, process 1100 may involve processor 1012 signaling the support of the one or more static preamble puncture patterns during a ranging negotiation phase.

In some implementations, in signaling the support of the one or more static preamble puncture patterns, process 1100 may involve processor 1012 indicating the one or more static preamble puncture patterns supported in a 320 MHz bandwidth. For instance, in indicating the one or more static preamble puncture patterns supported in the 320 MHz bandwidth, process 1100 may involve processor 1012 indicating at least one of: (i) a first preamble puncture set comprising a continuous 320 MHz segment and a continuous 240 MHz segment; and (ii) a second preamble puncture set comprising all other puncture patterns predefined for the 320 MHz bandwidth. Moreover, all other puncture patterns predefined for the 320 MHz bandwidth may include puncture patterns specified in Table 36-30 of the IEEE 802.11bk specification.

In some implementations, in signaling the support of the one or more static preamble puncture patterns, process 1100 may involve processor 1012 indicating the one or more static preamble puncture patterns supported in either or both of an 80 MHz bandwidth and a 160 MHz bandwidth. For instance, in indicating the one or more static preamble puncture patterns supported in the either or both of the 80 MHz bandwidth and the 160 MHz bandwidth, process 1100 may involve processor 1012 indicating at least one of: (i) a first preamble puncture set comprising a continuous segment of 60 MHz or greater in the 80 MHz bandwidth; (ii) a second preamble puncture set comprising all other puncture patterns predefined for the 80 MHz bandwidth; (iii) a third preamble puncture set comprising a continuous segment of 120 MHz or greater in the 160 MHz bandwidth; and (iv) a fourth preamble puncture set comprising all other puncture patterns predefined for the 160 MHz bandwidth. Furthermore, all other puncture patterns predefined for the 80 MHz bandwidth and the 160 MHz bandwidth may include puncture patterns specified in Table 36-30 of the IEEE 802.11bk specification.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
signaling a support of one or more static preamble puncture patterns; and
performing at least one of ranging and sensing in a wireless local area network (WLAN) with at least one of the one or more static preamble puncture patterns.

2. The method of claim 1, wherein the signaling of the support of the one or more static preamble puncture patterns comprises transmitting, to a responding station (RSTA), an initial fine timing measurement request (IFTMR) indicating the support of the one or more static preamble puncture patterns.

3. The method of claim 2, wherein the signaling of the support of the one or more static preamble puncture patterns further comprises receiving, from the RSTA, an initial fine timing measurement (IFTM) indicating its support of equal to or fewer than the one or more static preamble puncture patterns.

4. The method of claim 1, wherein the signaling of the support of the one or more static preamble puncture patterns comprises receiving, from an initiating station (ISTA), an initial fine timing measurement request (IFTMR) indicating its support of one or more other static preamble puncture patterns.

5. The method of claim 4, wherein the signaling of the support of the one or more static preamble puncture patterns further comprises transmitting, to the ISTA, an initial fine timing measurement (IFTM) indicating the support of the one or more static preamble puncture patterns that are equal to or more than the one or more static preamble puncture patterns.

6. The method of claim 1, wherein the signaling of the support of the one or more static preamble puncture patterns comprises signaling the support of the one or more static preamble puncture patterns during a ranging negotiation phase.

7. The method of claim 1, wherein the signaling of the support of the one or more static preamble puncture patterns comprises indicating the one or more static preamble puncture patterns supported in a 320 MHz bandwidth.

8. The method of claim 7, wherein the indicating of the one or more static preamble puncture patterns supported in the 320 MHz bandwidth comprises indicating at least one of:
a first preamble puncture set comprising a continuous 320 MHz segment and a continuous 240 MHz segment; and
a second preamble puncture set comprising all other puncture patterns predefined for the 320 MHz bandwidth.

9. The method of claim 1, wherein the signaling of the support of the one or more static preamble puncture patterns comprises indicating the one or more static preamble puncture patterns supported in either or both of an 80 MHz bandwidth and a 160 MHz bandwidth.

10. The method of claim 9, wherein the indicating of the one or more static preamble puncture patterns supported in the either or both of the 80 MHz bandwidth and the 160 MHz bandwidth comprises indicating at least one of:
a first preamble puncture set comprising a continuous segment of 60 MHz or greater in the 80 MHz bandwidth;
a second preamble puncture set comprising all other puncture patterns predefined for the 80 MHz bandwidth;
a third preamble puncture set comprising a continuous segment of 120 MHz or greater in the 160 MHz bandwidth; and
a fourth preamble puncture set comprising all other puncture patterns predefined for the 160 MHz bandwidth.

11. An apparatus, comprising:
a transceiver configured to communicate wirelessly; and
a processor coupled to the transceiver and configured to perform, via the transceiver, operations:
signaling a support of one or more static preamble puncture patterns; and
performing at least one of ranging and sensing in a wireless local area network (WLAN) with at least one of the one or more static preamble puncture patterns.

12. The apparatus of claim 11, wherein the signaling of the support of the one or more static preamble puncture patterns comprises transmitting, to a responding station (RSTA), an initial fine timing measurement request (IFTMR) indicating the support of the one or more static preamble puncture patterns.

13. The apparatus of claim 12, wherein the signaling of the support of the one or more static preamble puncture patterns further comprises receiving, from the RSTA, an initial fine timing measurement (IFTM) indicating its support of equal to or fewer than the one or more static preamble puncture patterns.

14. The apparatus of claim 11, wherein the signaling of the support of the one or more static preamble puncture patterns comprises receiving, from an initiating station (ISTA), an initial fine timing measurement request (IFTMR) indicating its support of one or more other static preamble puncture patterns.

15. The apparatus of claim 14, wherein the signaling of the support of the one or more static preamble puncture patterns further comprises transmitting, to the ISTA, an initial fine timing measurement (IFTM) indicating the support of the one or more static preamble puncture patterns that are equal to or more than the one or more static preamble puncture patterns.

16. The apparatus of claim 11, wherein the signaling of the support of the one or more static preamble puncture patterns comprises signaling the support of the one or more static preamble puncture patterns during a ranging negotiation phase.

17. The apparatus of claim 11, wherein the signaling of the support of the one or more static preamble puncture patterns comprises indicating the one or more static preamble puncture patterns supported in a 320 MHz bandwidth.

18. The apparatus of claim 17, wherein the indicating of the one or more static preamble puncture patterns supported in the 320 MHz bandwidth comprises indicating at least one of:
a first preamble puncture set comprising a continuous 320 MHz segment and a continuous 240 MHz segment; and
a second preamble puncture set comprising all other puncture patterns predefined for the 320 MHz bandwidth.

19. The apparatus of claim 11, wherein the signaling of the support of the one or more static preamble puncture patterns comprises indicating the one or more static preamble puncture patterns supported in either or both of an 80 MHz bandwidth and a 160 MHz bandwidth.

20. The apparatus of claim 19, wherein the indicating of the one or more static preamble puncture patterns supported in the either or both of the 80 MHz bandwidth and the 160 MHz bandwidth comprises indicating at least one of:
a first preamble puncture set comprising a continuous segment of 60 MHz or greater in the 80 MHz bandwidth;
a second preamble puncture set comprising all other puncture patterns predefined for the 80 MHz bandwidth;
a third preamble puncture set comprising a continuous segment of 120 MHz or greater in the 160 MHz bandwidth; and
a fourth preamble puncture set comprising all other puncture patterns predefined for the 160 MHz bandwidth.
